(19) United States
(12) Patent Application Publication
(10) Pub. No.: US 2025/0368332 A1
(43) Pub. Date: Dec. 4, 2025

(54) PERSONS WITH REDUCED MOBILITY LAVATORY WALL PULL AND TRANSLATE TO STOW

(71) Applicant: B/E AEROSPACE, INC., Winston Salem, NC (US)

(72) Inventors: Scott Marley, Everett, WA (US); Raquel Barral Ruiz, Kirkland, WA (US); PAUL MURRAY, Langley, WA (US)

(73) Assignee: B/E AEROSPACE, INC., Winston Salem, NC (US)

(21) Appl. No.: 18/680,846

(22) Filed: May 31, 2024

(51) Int. Cl. B64D 11/02

(52) U.S. Cl. CPC B64D 11/02

(57) ABSTRACT

An aircraft lavatory monument is provided that includes a first lavatory comprising a first door providing access to the first lavatory from an aisle of an aircraft, a second lavatory proximate the first lavatory, the second lavatory comprising a second door providing access to the second lavatory from the aisle of the aircraft, and a movable wall disposed between the first lavatory and the second lavatory. In a first position, the movable wall separates the first lavatory from the second lavatory providing privacy therebetween. In a second position, the movable wall is translated toward an outer wall of the aircraft lavatory monument thereby combining the first lavatory and the second lavatory.

### FIELD

The present disclosure generally relates persons with reduced mobility lavatories, and more specifically to a wall within a persons with reduced mobility lavatory.

### BACKGROUND

A lavatory monument installed in an aircraft may be located against an outboard wall portion of an aircraft passenger cabin as well as the rear of the aircraft abutting the pressure dome. For ease of manufacture and ease of installation adjacent other interior structures, aircraft lavatories typically have flat walls on all sides facing the aircraft interior as depicted by the lavatory envelope. Aircraft lavatories are typically located adjacent a doorway emergency exit path.

To provide a space for a crew member to stand by an emergency exit door for the purpose of assisting passengers during an emergency evacuation of an aircraft, airworthiness authorities require that a 12-inch (30.48 centimeters) by 20-inch (50.8 centimeters) “assist space” be provided adjacent the aircraft exit doorway, alongside the exit path but outside the exit path itself. Attendant seats, occupied by flight attendants during takeoff, landing and at other times are typically mounted inboard of the assist spaces near the exit paths. The attendant seats most typically fold upward to a stowed position when not occupied so as to remain clear of the exit path.

Typical lavatory monuments comprise two lavatories which are configured with similar or identical water supply and sewage systems and structural layouts to minimize production cost and certification effort. Each lavatory in the lavatory monument may be a physically separate structural unit with a gap designed therebetween to minimize the possibility that the units will contact one another during flight and/or emergency landing situations.

A variety of techniques have been employed for transferring a mobility-impaired passenger between an aisle wheelchair and a toilet. A 90° transfer in which the aisle wheelchair is positioned at a 90° angle to the toilet and an assistant lifts the mobility-impaired passenger and rotates the passenger onto the toilet, and vice versa, has been found to reduce the risk of injury to the assistant and is, therefore, a favored method for assisted transfers. A lateral transfer, in which a mobility-impaired passenger slides sideways from wheelchair to toilet and vice versa can be favored for an unassisted transfer in which the mobility-impaired passenger prefers to make the transfer unaided and has the upper body strength to do so.

Existing lavatory solutions for persons with reduced mobility (PRM) include a wall at a centerline of the lavatory monument on a twin aisle aircraft, and a dedicated aft lavatory or galley complex on a narrow body aircraft. PRM lavatories, located against the outboard wall portion of the aircraft, are typically single oversized units which occupy an enlarged footprint in the aircraft cabin.

Conventionally, a PRM lavatory may include an outboard folding removable center wall. Such removable wall is difficult to fold and remove. A substantial effort and space is needed to fold the wall and move it. To build a PRM lavatory, generally an existing footprint or layout of a typical lavatory needs to be modified. That, in turn, requires relocating utilities such as electrical conduits, water supplies and drain systems.

### SUMMARY

Disclosed herein is an aircraft lavatory monument, including a first lavatory comprising a first door providing access to the first lavatory from an aisle of an aircraft, a second lavatory proximate the first lavatory, the second lavatory comprising a second door providing access to the second lavatory from the aisle of the aircraft, and a movable wall disposed between the first lavatory and the second lavatory. In a first position, the movable wall separates the first lavatory from the second lavatory providing privacy therebetween. In a second position, the movable wall is translated toward an outer wall of the aircraft lavatory monument thereby combining the first lavatory and the second lavatory.

In various embodiments, the movable wall is translated toward the outer wall of the aircraft lavatory monument by: translating the movable wall in a first direction toward an interior of the aircraft, translating the movable wall in a second direction perpendicular to the first direction toward the outer wall of the aircraft lavatory monument, and translating the movable wall in a third direction opposite the first direction in order to stow the movable wall within the aircraft lavatory monument adjacent to the outer wall of the aircraft lavatory monument.

In various embodiments, the aircraft lavatory monument further includes a first rail. In various embodiments, the translating in the first direction and the third direction is via the first rail.

In various embodiments, the aircraft lavatory monument, further includes a set of second rails. In various embodiments, the translating in the second direction is via the set of second rails.

In various embodiments, the movable wall is coupled to the first rail and wherein the first rail is coupled to the set of second rails.

In various embodiments, the aircraft lavatory monument, further includes a latching mechanism. In various embodiments, the latching mechanism is configured within the movable wall. In various embodiments, the latching mechanism includes a handle and at least one pin. In various embodiments, the at least one pin is coupled to the handle. In various embodiments, responsive to the handle being articulated, the at least one pin is configured to either lock the movable wall to at least one of a ceiling or a floor of the aircraft lavatory monument or unlock the movable wall to at least one of the ceiling or the floor of the aircraft lavatory monument.

In various embodiments, the aircraft lavatory monument further includes a first fixed panel. In various embodiments, in the first position, the movable wall is temporarily coupled to the first fixed panel.

In various embodiments, the aircraft lavatory monument further includes a second fixed panel. In various embodiments, in the second position, the movable wall is temporarily coupled to the second fixed panel.

In various embodiments, the movable wall comprises a female interface component that interfaces with at least one of a first male interface component on the first fixed panel or a second male interface component on the second fixed panel at a given time.

Also disclosed herein is an aircraft. The aircraft includes an aircraft lavatory monument. The aircraft lavatory monument includes a first lavatory comprising a first door providing access to the first lavatory from an aisle of an aircraft, a second lavatory proximate the first lavatory, the second lavatory comprising a second door providing access to the second lavatory from the aisle of the aircraft, and a movable wall disposed between the first lavatory and the second lavatory. In a first position, the movable wall separates the first lavatory from the second lavatory providing privacy therebetween. In a second position, the movable wall is translated toward an outer wall of the aircraft lavatory monument thereby combining the first lavatory and the second lavatory.

In various embodiments, the movable wall is translated toward the outer wall of the aircraft lavatory monument by: translating the movable wall in a first direction toward an interior of the aircraft, translating the movable wall in a second direction perpendicular to the first direction toward the outer wall of the aircraft lavatory monument, and translating the movable wall in a third direction opposite the first direction in order to stow the movable wall within the aircraft lavatory monument adjacent to the outer wall of the aircraft lavatory monument.

In various embodiments, the aircraft lavatory monument further includes a first rail. In various embodiments, the translating in the first direction and the third direction is via the first rail

In various embodiments, the aircraft lavatory monument, further includes a set of second rails. In various embodiments, the translating in the second direction is via the set of second rails.

In various embodiments, the movable wall is coupled to the first rail and wherein the first rail is coupled to the set of second rails.

In various embodiments, the aircraft lavatory monument, further includes a latching mechanism. In various embodiments, the latching mechanism is configured within the movable wall. In various embodiments, the latching mechanism includes a handle and at least one pin. In various embodiments, the at least one pin is coupled to the handle. In various embodiments, responsive to the handle being articulated, the at least one pin is configured to either lock the movable wall to at least one of a ceiling or a floor of the aircraft lavatory monument or unlock the movable wall to at least one of the ceiling or the floor of the aircraft lavatory monument.

In various embodiments, the aircraft lavatory monument further includes a first fixed panel. In various embodiments, in the first position, the movable wall is temporarily coupled to the first fixed panel.

In various embodiments, the aircraft lavatory monument further includes a second fixed panel. In various embodiments, in the second position, the movable wall is temporarily coupled to the second fixed panel.

In various embodiments, the movable wall comprises a female interface component that interfaces with at least one of a first male interface component on the first fixed panel or a second male interface component on the second fixed panel at a given time.

Also disclosed herein is a method of converting an aircraft lavatory monument comprising a first lavatory and a second lavatory separated by a movable wall to a combined lavatory configuration. The method includes articulating a latching mechanism positioned on an exterior edge of the movable wall and accessible from an aisle of an aircraft from a first position to a second position to unlock the movable wall, translating the movable wall in a first direction toward an interior of the aircraft, translating the movable wall in a second direction perpendicular to the first direction toward an outer wall of the aircraft lavatory monument, and translating the movable wall in a third direction opposite the first direction in order to stow the movable wall within the aircraft lavatory monument adjacent to the outer wall of the aircraft lavatory monument.

In various embodiments, the method further includes articulating the latching mechanism from the second position to the first position to lock the movable wall in a stowed position.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates a partial top view of an aircraft cabin with an exemplary lavatory outboard dual monument, in accordance with various embodiments.

FIGS. 2A, 2B, 2C, and 2D illustrate a lavatory monument, in accordance with various embodiments.

FIG. 3A illustrates a viewpoint of a lavatory monument in a two independent lavatory configuration, in accordance with various embodiments.

FIG. 3B illustrates a viewpoint of a lavatory monument in a combined lavatory configuration, in accordance with various embodiments.

FIG. 4A illustrates a top view of a lavatory monument in a first or divided configuration, in accordance with various embodiments.

FIG. 4B illustrates a top view of a lavatory monument in a second or combined configuration, in accordance with various embodiments.

FIGS. 5A and 5B illustrate a mechanism for translating a movable wall 230 from a divided position to a stowed position, in accordance with an illustrative embodiment.

FIGS. 6A and 6B illustrate a mechanism for coupling a movable wall to either a first fixed panel or a second fixed panel, in accordance with an illustrative embodiment.

FIGS. 7A and 7B illustrate a mechanism for coupling a movable wall to either a first fixed panel or a second fixed panel, in accordance with an illustrative embodiment.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

Typical aircraft lavatories in some aircrafts may be restricted in allowing wheelchair access. Single aisle aircrafts are particularly restricted. A persons with reduced mobility (PRM) lavatory may include a folding movable center wall. However, such a movable wall may be difficult to fold and move. When used to create two independent lavatories, this movable wall should ensure that no passenger can unlatch the door from one side and intrude or peek into the other lavatory's space. The solution currently used to avoid this is to have several latches on both sides of the panel. This means that, when the lavatory needs to be configured to a combined lavatory configuration, the flight crew has to access both lavatories. Further, there is no means to avoid a passenger from deploying the latches on one side, then the other, and at some point peeking or pushing the wall into the other lavatory's space. A second concern is that the current solution has latches next to the floor, so the flight crew has to reach into the lavatory floor to undo the latches. They are hesitant to do this as the floor of the lavatory may be not clean from time to time.

Disclosed herein is a system and methods for pulling and translating a monolithic movable wall within a persons with reduced mobility lavatory. In various embodiments, the monolithic movable wall may be easily moved without reaching inside either of the lavatories for additional latching. In various embodiments, a crew member may easily identify whether the monolithic movable wall is latched from a front of the lavatory, which reduces an unlatched monolithic movable wall from going unnoticed. In various embodiments, responsive to the crew member translating a handle disposed on an outer edge of monolithic movable wall from a locked position to an unlocked position, the monolithic movable wall is unlocked from a divided position and the crew member may translate the monolithic movable wall a first direction toward an interior of the aircraft. In various embodiments, the monolithic movable wall is only moved in the first direction in a first amount such that an inner edge of the monolithic movable wall is able to clear a toilet in the reduced mobility lavatory. In various embodiments, the translation in the first direction is restricted by a first rail on which the monolithic movable wall translates. In various embodiments, once crew member has translated the monolithic movable wall in the first direction in the first amount to clear a toilet in the reduced mobility lavatory, the crew member may then translate the monolithic movable wall in a second direction perpendicular to the first direction so as to move the monolithic movable wall toward an outer wall of the reduced mobility lavatory. In various embodiments, the translation in the second direction is restricted by a set of second rails to which the first rail is coupled. In various embodiments, once the monolithic movable wall has been translated in the second direction toward the outer wall of the reduced mobility lavatory, the crew member may then translate the monolithic movable wall in a third direction opposite the first direction in order to stow the monolithic movable wall within the reduced mobility lavatory adjacent to the outer wall of the reduced mobility lavatory. In various embodiments, the translation in the third direction is restricted by the first rail on which the monolithic movable wall translates. In various embodiments, once in the stowed position, the crew member may translate the handle disposed on the outer edge of monolithic movable wall to a locked position thereby locking the monolithic movable wall in the stowed position. In various embodiments, the process is reversed to separate the reduced mobility lavatory when not required by a person with reduced mobility.

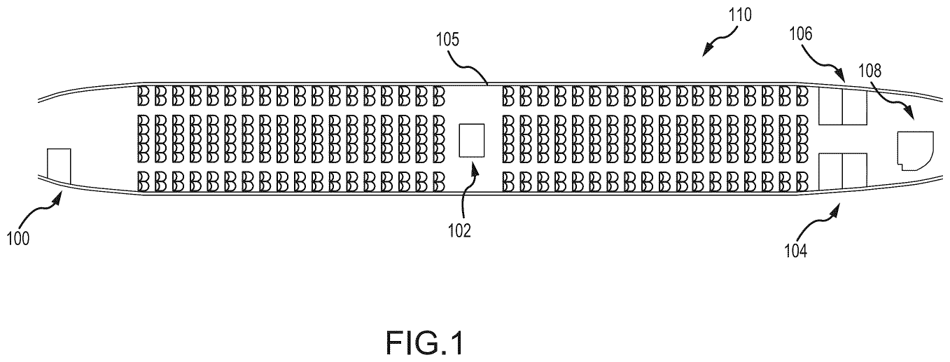

Referring now to FIG. 1, in accordance with various embodiments, a partial top view of an aircraft cabin with an exemplary aircraft lavatory monument, referred to hereafter as a lavatory monument, is illustrated. In the depicted figure, numerous lavatory monuments 100, 102, 104, 106, and 108 are shown with some located along an outboard wall 105 and/or in a center of the aircraft. Lavatory monument 100 is located approximately toward the front of the aircraft, lavatory monument 102 is located approximately in the middle of the fuselage (e.g., near a wing), and lavatory monuments 104, 106, and 108 are located toward the rear of an aircraft 110. The outboard wall 105 may be formed as a curved body of the fuselage of the aircraft 110. The lavatory monuments 104, 106, and 108 are a complex of two adjacent compartments separated by a divider wall. In various embodiments, the lavatory monuments 104, 106, and 108 may be selectively configurable from two separated compartments to a unified private lavatory space by selectively stowing the divider wall to provide a combined and enlarged space for persons with restricted mobility (PRM), or to provide room for an assistant to be in the lavatory space as an aid for the PRM. In various embodiments, the movable wall may be translated to form the unified space, and then secured in a stowed position, for example, with floor and/or ceiling locks. In various embodiments, the movable wall may form a barrier that May conveniently keep the assistant separated from a wet sink area and may advantageously protect the sink area from collision or abrasion from a wheelchair, for example.

In the depicted example, an area between the lavatory monuments 104, 106, and 108 and the door is an open area with additional space for maneuvering, for example, a wheelchair. In that regard, access to one or more of lavatory monuments 100, 102, 104, 106, and 108 may be from one or more sides or a front of the lavatory monuments 100, 102, 104, 106, and 108. Note that the drawing is not necessarily shown to scale and is merely illustrative of one possible configuration of the lavatory monuments 100, 102, 104, 106, and 108 in a cabin of the aircraft 110. Configuration of the aisle and seats may be in any suitable arrangement that permits ingress and egress through either of the two doors provided in the lavatory monuments 104, 106, and 108. In various embodiments, the lavatory monument may be located in an aft portion of the aircraft (e.g., near the pressure dome), or in a forward portion of the aircraft (e.g., immediately aft of the cockpit).

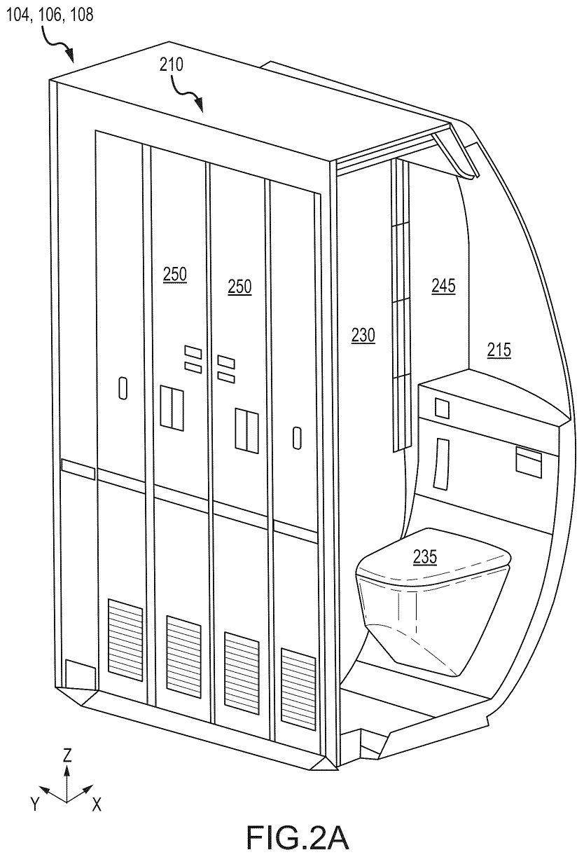

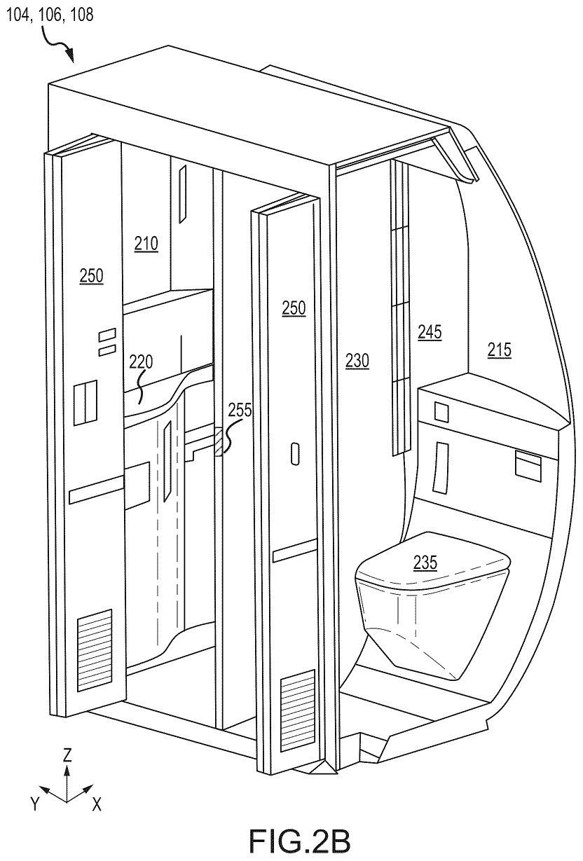

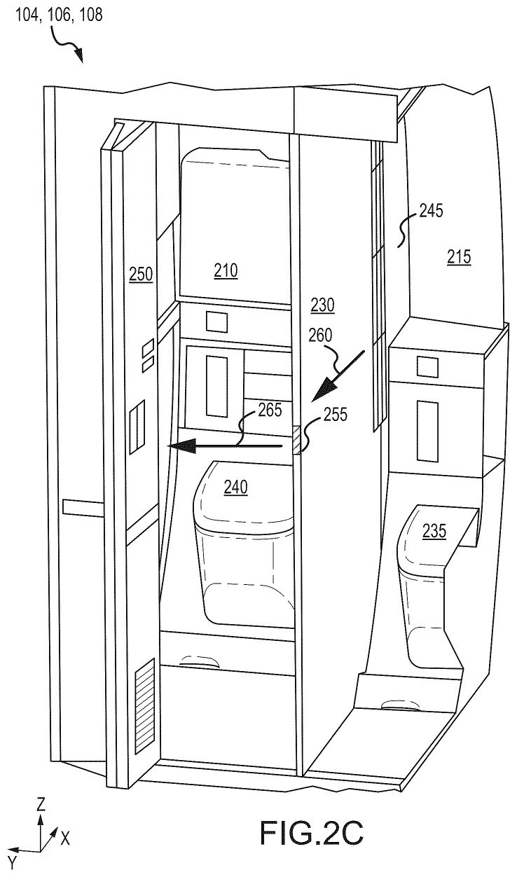

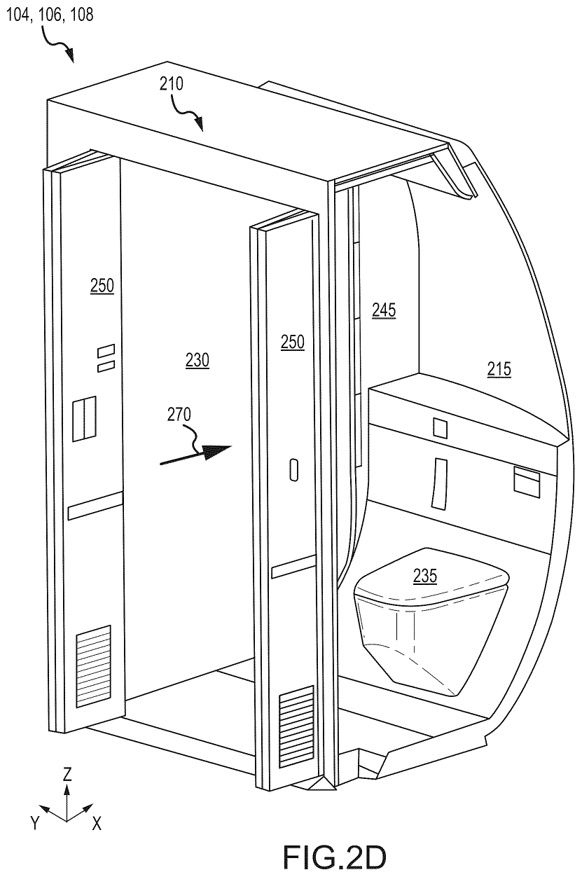

Referring now to FIGS. 2A, 2B, 2C, and 2D, in accordance with various embodiments, a lavatory monument 104, 106, or 108 is illustrated. In various embodiments, lavatory 210 includes a toilet 240 and a sink 220. In various embodiments, in a two independent lavatory configuration, movable wall 230 is deployed to divide the lavatory 210 from the lavatory 215. In various embodiments, the movable wall 230 is temporarily coupled to a first fixed panel 245 of the lavatory monument 104, 106, or 108. In various embodiments, as is illustrated in FIG. 2B, with doors 250 open, movable wall 230 is temporarily coupled to the first fixed panel 245 and divides the lavatory 210 from the lavatory 215. In various embodiments, the doors 250 may be two single piece slab doors or two multipaneled bifold doors, among others.

With reference to FIG. 2C, in various embodiments, in order to combine lavatories 210 and 215 for a person with reduced mobility, a crew member may articulate the handle 255 so as to unlock the movable wall 230 via one or more latching mechanisms that temporarily couple the movable wall 230 to a ceiling and/or a floor of the lavatory monument 104, 106, or 108. In various embodiments, the latching mechanisms may include pins that protrude from the movable wall 230 into the ceiling and/or the floor of the lavatory monument 104, 106, or 108. In various embodiments, the handle 255 may be disposed on an outer edge of the movable wall 230. In various embodiments, the handle 255 may be coupled to the pins internally within the movable wall 230 via a linking mechanism. In various embodiments, the handle 255 may be articulated by being rotated in either a clockwise or counterclockwise direction, thereby pulling the pins inward into the movable wall 230. In various embodiments, the handle 255 may be articulated by translating the handle 255 outward from the movable wall 230 thereby pulling the pins inward into the movable wall 230. In various embodiments, it is noted that other ways of articulating the handle 255 are envisioned without departing from the spirit and scope of the invention.

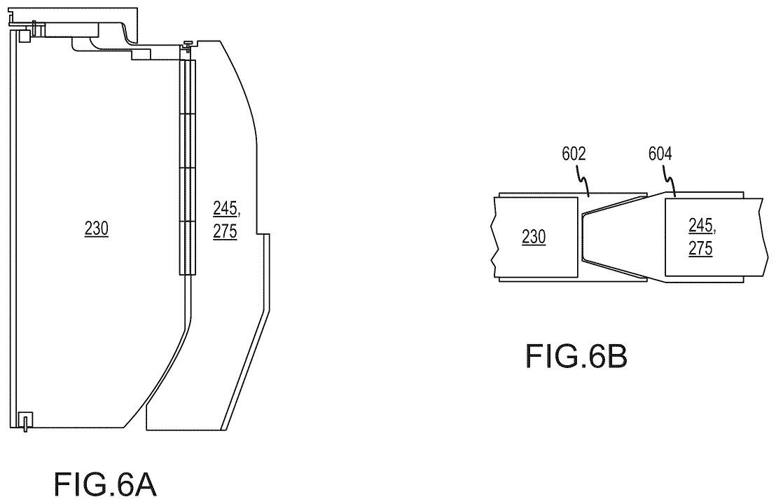

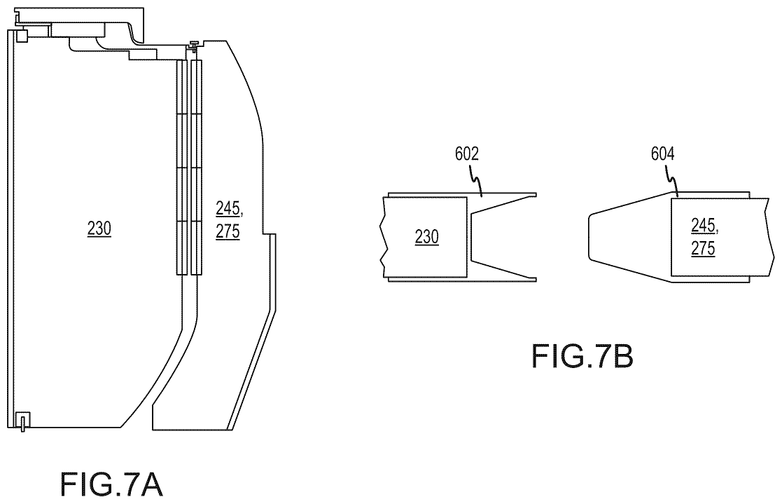

In various embodiments, responsive to the crew member translating the handle 255 such that the pins are withdrawn into the movable wall 230, i.e. from a locked position to an unlocked position, the movable wall 230 may translate in a first direction 260 either toward an interior of the aircraft or toward an aisle of the aircraft depending on a location of the lavatory within the aircraft. In various embodiments, the movable wall 230 may translate in the first direction 260 in order to disengage from the movable wall 230 from the fixed panel 245 as is illustrated hereafter in relation to FIGS. 6A, 6B, 7A, and 7B. In various embodiments, the movable wall 230 is only moved in the first direction 260 in a first amount such that an inner edge of the monolithic movable wall is able to clear the toilet 240. In various embodiments, the translation in the first direction 260 is restricted by a first rail on which the movable wall 230 translates in the first direction 260. In various embodiments, once crew member has translated the movable wall 230 in the first direction 260 in the first amount to clear the toilet 240, the crew member may then translate the movable wall 230 in a second direction 265 perpendicular to the first direction 260 so as to move the movable wall 230 toward an outer wall of the lavatory monument 104, 106, or 108. In various embodiments, the translation in the second direction 265 is restricted by a set of second rails to which the first rail is coupled.

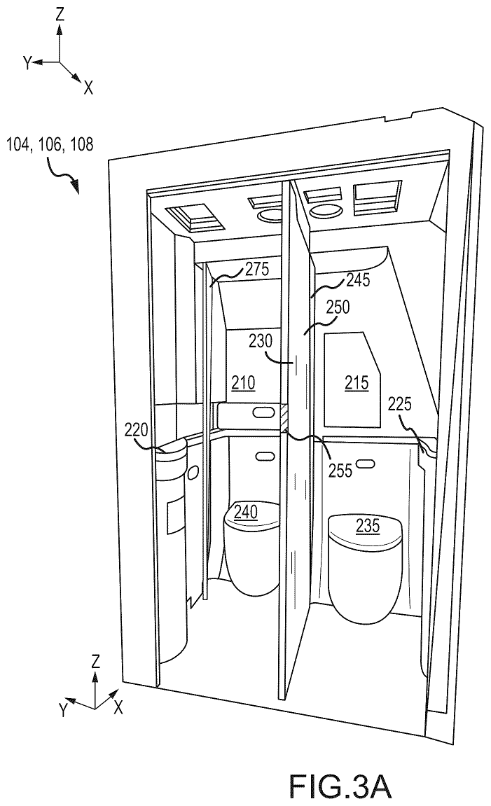

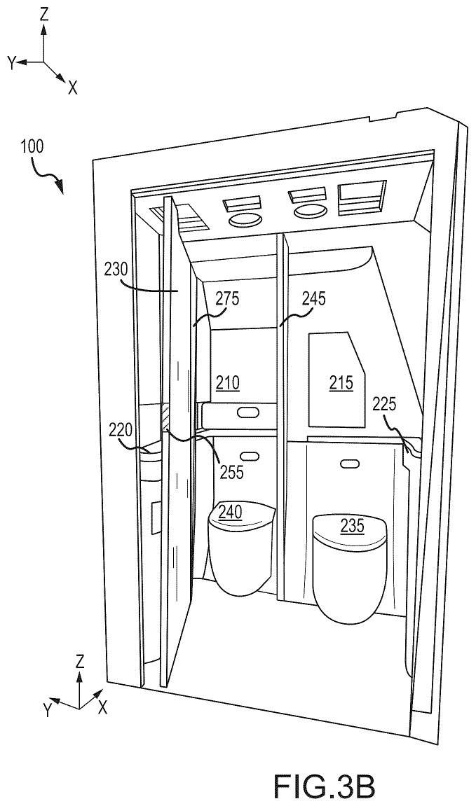

With reference to FIG. 2D, in various embodiments, once the movable wall 230 has been translated in the second direction 265 toward the outer wall of the lavatory monument 104, 106, or 108, the crew member may then translate the movable wall 230 in a third direction 270 opposite the first direction 260 in order to stow the movable wall 230 within the lavatory monument 104, 106, or 108 adjacent to the outer wall of the lavatory monument 104, 106, or 108. In various embodiments, the movable wall 230 may translate in the third direction 270 in order to engage the movable wall 230 with a fixed panel, such as fixed panel 275 described hereafter in FIGS. 3A and 3B and in further relation to FIGS. 6A, 6B, 7A, and 7B.

In various embodiments, the translation in the third direction 270 is restricted by the first rail on which the movable wall 230 translates. In various embodiments, once in the stowed position, the crew member may translate the handle 255 disposed on the outer edge of the movable wall 230 to a locked position thereby locking the movable wall 230 in the stowed position. In various embodiments, the process is reversed to separate the lavatory monument 104, 106, or 108 when not required by a person with reduced mobility.

Referring now to FIG. 3A, in accordance with various embodiments, another viewpoint of lavatory monument 104, 106, or 108 in a two independent lavatory 210 and 215 configuration is illustrated. In various embodiments, the lavatory 210 includes a toilet 240 and a sink 220. In various embodiments, the lavatory 215 includes a toilet 235 and a sink 225. In various embodiments, in a two independent lavatory configuration, movable wall 230 is deployed to divide the lavatory 210 from the lavatory 215. In various embodiments, the movable wall 230 is temporarily coupled to the first fixed panel 245 of the lavatory monument 104, 106, or 108. In various embodiments, the lavatory monument 104, 106, or 108 further includes a second fixed panel 275 for use in a combined lavatory configuration in order to stow the movable wall 230.

Referring now to FIG. 3B, in accordance with various embodiments, the lavatory monument 104, 106, or 108 in a combined lavatory configuration is illustrated. In various embodiments, the lavatory 210 includes a toilet 240 and a sink 220. In various embodiments, the lavatory 215 includes a toilet 235 and a sink 225. In various embodiments, in the combined lavatory configuration, the movable wall 230 is translated toward an outer wall of the lavatory monument 104, 106, or 108. As noted previously, the movable wall 230 is translated by a crew member articulating the handle 255 so as to unlock the movable wall 230 via one or more latching mechanisms that temporarily couple the movable wall 230 to a ceiling and/or a floor of the lavatory monument 104, 106, or 108. In various embodiments, responsive to the crew member translating the handle 255 such that the pins are withdrawn into the movable wall 230, i.e. from a locked position to an unlocked position, the crew member may translate the movable wall 230 in a first direction toward an interior of the aircraft, translate the movable wall 230 in a second direction perpendicular to the first direction so as to move the movable wall 230 toward an outer wall of the lavatory monument 104, 106, or 108, and then translate the movable wall 230 in a third direction opposite the first direction in order to stow the movable wall 230 within the lavatory monument 104, 106, or 108 adjacent to the outer wall of the lavatory monument 104, 106, or 108. In various embodiments, stowing the movable wall 230 in the stowed position includes temporarily coupling the movable wall 230 with the second fixed panel 275 of the lavatory monument 104, 106, or 108.

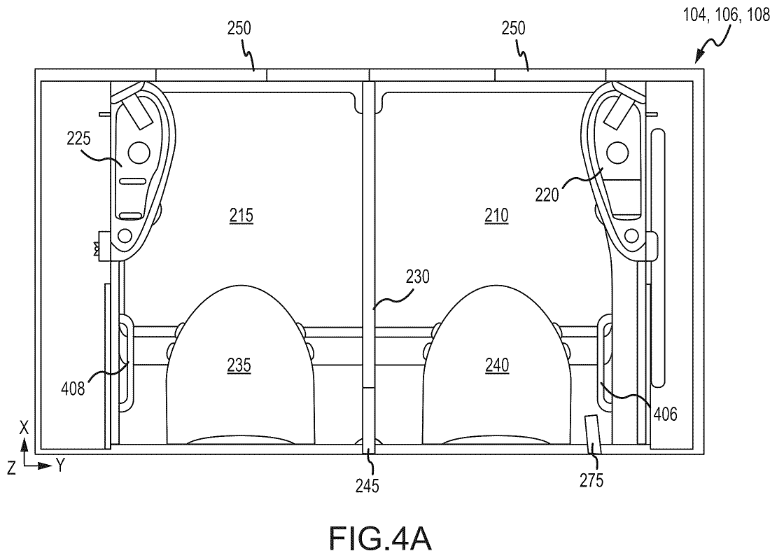

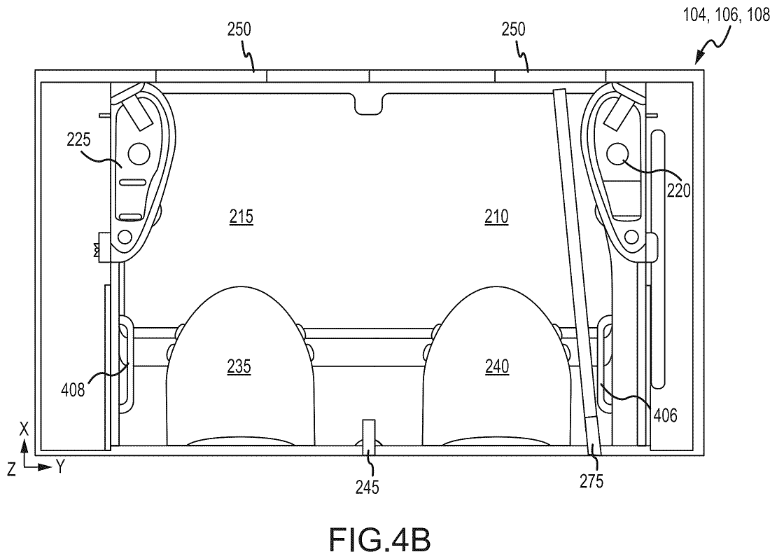

Referring now to FIG. 4A, in accordance with various embodiments, a top view of a lavatory monument 104, 106, or 108 in a first configuration is illustrated. In various embodiments, lavatories 210 and 215 have a “mirror image” arrangement of a sink 220 and a sink 225, respectively, toilet 240 and toilet 235, respectively, stability bars 406 and 408, respectively, which are mounted for use as support in lavatories 210 and 215. In various embodiments, lavatories 210 and 215 are separated by a movable wall 230 that provides privacy between a toilet 235 in the lavatory 215 and a toilet 240 in the lavatory 210. In various embodiments, lavatory 210 and lavatory 215 are substantially similar and a substantial mirror image of each other when configured as divided by the movable wall 230 into two separate compartments. In various embodiments, the movable wall 230 is in a divided position. In various embodiments, when the movable wall 230 is divided position (which may also be referred to herein as the first position), the movable wall 230 allows independent access to lavatory 210, 215 via bifold doors 250.

As will be described in further detail with additional reference to FIG. 4B, in various embodiments, the lavatory monument 104, 106, or 108 includes a first fixed panel 245 and a second fixed panel 275 to which the movable wall 230 may temporarily couple depending on a current configuration of the lavatory monument 104, 106, or 108. In various embodiments, toilet 240 is located against the outer wall approximately at a center of the lavatory 210. In various embodiments, sink 220 is connected to a water supply and sewage system. In various embodiments, lavatory 210 is also connected to electrical and environmental utilities. In a retrofit application, in various embodiments, the layout of lavatory 210 preferably matches that of a previously installed lavatory monument such that the utilities can be connected without substantial rework or relocation of the utilities. In various embodiments, lavatory 210 provides a first space for a person to move inside lavatory 210. In various embodiments, the first space has a limited size and dimension constrained by bifold door 302, the movable wall 230, sink 220, and toilet 240. Accordingly, lavatory 210 has, in the various embodiments, enough room for only one person to move about in a comfortable manner. Furthermore, in various embodiments, if a person with reduced mobility (e.g., disabled, elderly, injured, etc.) enters lavatory 210, then an assistant. i.e., a second person, may not have sufficient space to assist the person on to toilet 240. Further, in various embodiments, if the first person requires a wheelchair, there may be no room to accept the wheelchair within lavatory 210. Similarly, in various embodiments, lavatory 215 includes toilet 235 and sink 225. In various embodiments, toilet 235 is located against the outer wall approximately at a center. Furthermore, in various embodiments, lavatory 215 also includes a second space, similar to the first space. Lavatory 215 is, in various embodiments, substantially a mirror image of lavatory 210. In a retrofit application, in various embodiments, the layout of lavatory 210 and 215 preferably matches that of a previously installed lavatory monument such that the utilities may be connected without substantial rework or relocation of the utilities.

In FIG. 4A, the movable wall 230 is in divided (or first) position. In various embodiments, the movable wall 230 is aligned with and temporarily coupled to the first fixed panel 245. In FIG. 4B, in accordance with various embodiments, a top view of a lavatory monument 104, 106, or 108 in a combined (or second) position is illustrated. In FIG. 3B, once unlocked, the crew member may translate the movable wall 230 in a first direction, i.e. in a positive x-direction, toward an interior of the aircraft, translate the movable wall 230 in a second direction, i.e. in a positive y-direction, perpendicular to the first direction so as to move the movable wall 230 toward an outer wall of the lavatory monument 104, 106, or 108, and then translate the movable wall 230 in a third direction, i.e. in a substantially negative x-direction, opposite the first direction in order to stow the movable wall 230 within the lavatory monument 104, 106, or 108 adjacent to the outer wall of the lavatory monument 104, 106, or 108. In various embodiments, stowing the movable wall 230 in the stowed position (which may also be referred to herein as the second position) includes temporarily coupling the movable wall 230 with the second fixed panel 275 of the lavatory monument 104, 106, or 108.

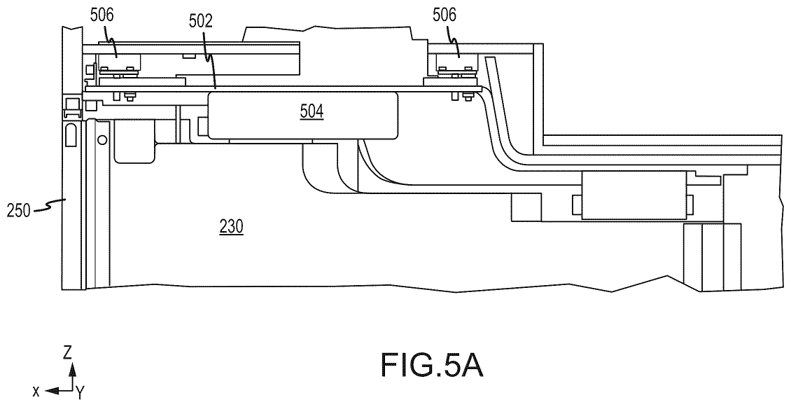

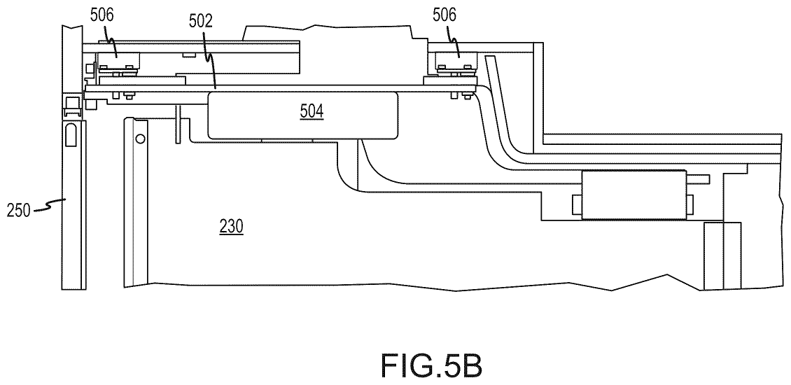

Referring now to FIGS. 5A and 5B, in accordance with various embodiments, a mechanism for translating a movable wall 230 from a divided position to a stowed position is illustrated. In various embodiments, the movable wall 230 is fixedly coupled to a first rail 502 via a coupling mechanism 504. In various embodiments, the coupling mechanism 504 is configured to allow the movable wall 230 to translate in a first direction toward an interior of the aircraft as well as in a third direction opposite the first direction via the first rail 502. In various embodiments, the first rail 502 is fixedly coupled to a set of second rails 506. In various embodiments, the set of second rails 506 are configured to allow the movable wall 230 and the first rail 502 to which the movable wall is fixedly coupled to translate in a second direction, i.e. in a positive y-direction, perpendicular to the first direction so as to move the movable wall 230 toward an outer wall of the lavatory monument 104, 106, or 108. In various embodiments, as illustrated in FIG. 5A, the movable wall 230 is in the divided position such that an outer edge of the movable wall 230 abuts the bifold doors 250. In various embodiments, as illustrated in FIG. 5BA, the movable wall 230 is in the stowed position such that an outer edge is disposed away from the bifold doors 250. In various embodiments, FIGS. 5A and 5B utilize pins 508 that are internally coupled to a handle, such as handle 255 of FIG. 2B, 2C, 3A, or 3B, within the movable wall 230 to secure the movable wall 230 in either the divided position or the stowed position.

Referring now to FIGS. 6A and 6B, in accordance with various embodiments, a mechanism for coupling a movable wall to either a first fixed panel or a second fixed panel is illustrated. In various embodiments, FIG. 6A illustrates a side view of the movable wall 230 temporarily coupled to the first fixed panel 245 or the second fixed panel 275. FIG. 6B illustrates a top view of the movable wall 230 temporarily coupled with the first fixed panel 245 or the second fixed panel 275. In various embodiments, the inner edge of the movable wall 230 includes a female interface component 602. In various embodiments the outer edge of the first fixed panel 245 or the second fixed panel 275 includes a male interface component 604. In various embodiments, the shape of the female interface component 602 may be inwardly trapezoidal, as illustrated, although shapes are also envisioned, such as inwardly semicircular or inwardly substantially triangular, among others. In various embodiments, the shape of the male interface component 604 may be outwardly trapezoidal, as illustrated, although shapes are also envisioned, such as outwardly semicircular or outwardly substantially triangular, among others.

Referring now to FIGS. 7A and 7B, in accordance with various embodiments, a mechanism for coupling a movable wall to either a first fixed panel or a second fixed panel is illustrated. In various embodiments, FIG. 7A illustrates a side view of the movable wall 230 temporarily separated from the first fixed panel 245 or the second fixed panel 275. FIG. 7B illustrates a top view of the movable wall 230 temporarily separated from the first fixed panel 245 or the second fixed panel 275. In various embodiments, the inner edge of the movable wall 230 includes a female interface component 602. In various embodiments the outer edge of the first fixed panel 245 or the second fixed panel 275 includes a male interface component 604. In various embodiments, the shape of the female interface component 602 may be inwardly trapezoidal, as illustrated, although shapes are also envisioned, such as inwardly semicircular or inwardly substantially triangular, among others. In various embodiments, the shape of the male interface component 604 may be outwardly trapezoidal, as illustrated, although shapes are also envisioned, such as outwardly semicircular or outwardly substantially triangular, among others.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about” or “approximately” as used herein represent an amount close to the stated amount that still performs a desired function or achieves a desired result. For example, the term “substantially,” “about” or “approximately” may refer to an amount that is within 10% of, within 5% of, within 1% of, within 0.1% of, and within 0.01% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. An aircraft lavatory monument, comprising:
a first lavatory comprising a first door providing access to the first lavatory from an aisle of an aircraft;
a second lavatory proximate the first lavatory, the second lavatory comprising a second door providing access to the second lavatory from the aisle of the aircraft; and
a movable wall disposed between the first lavatory and the second lavatory,
wherein, in a first position, the movable wall separates the first lavatory from the second lavatory providing privacy therebetween, and
wherein, in a second position, the movable wall is translated toward an outer wall of the aircraft lavatory monument thereby combining the first lavatory and the second lavatory.

2. The aircraft lavatory monument of claim 1, wherein the movable wall is translated toward the outer wall of the aircraft lavatory monument by:
translating the movable wall in a first direction toward an interior of the aircraft;
translating the movable wall in a second direction perpendicular to the first direction toward the outer wall of the aircraft lavatory monument; and
translating the movable wall in a third direction opposite the first direction in order to stow the movable wall within the aircraft lavatory monument adjacent to the outer wall of the aircraft lavatory monument.

3. The aircraft lavatory monument of claim 2, further comprising:
a first rail, wherein the translating in the first direction and the third direction is via the first rail.

4. The aircraft lavatory monument of claim 3, further comprising:
a set of second rails, wherein the translating in the second direction is via the set of second rails.

5. The aircraft lavatory monument of claim 4, wherein the movable wall is coupled to the first rail and wherein the first rail is coupled to the set of second rails.

6. The aircraft lavatory monument of claim 1, further comprising:
a latching mechanism, wherein the latching mechanism is configured within the movable wall and wherein the latching mechanism comprises:
a handle; and
at least one pin, wherein the at least one pin is coupled to the handle and wherein, responsive to the handle being articulated, the at least one pin is configured to either lock the movable wall to at least one of a ceiling or a floor of the aircraft lavatory monument or unlock the movable wall to at least one of the ceiling or the floor of the aircraft lavatory monument.

7. The aircraft lavatory monument of claim 1, further comprising:
a first fixed panel, wherein, in the first position, the movable wall is temporarily coupled to the first fixed panel.

8. The aircraft lavatory monument of claim 7, further comprising:
a second fixed panel, wherein, in the second position, the movable wall is temporarily coupled to the second fixed panel.

9. The aircraft lavatory monument of claim 8, wherein the movable wall comprises a female interface component that interfaces with at least one of a first male interface component on the first fixed panel or a second male interface component on the second fixed panel at a given time.

10. An aircraft, the aircraft comprising:
an aircraft lavatory monument, the aircraft lavatory monument comprising:
a first lavatory comprising a first door providing access to the first lavatory from an aisle of the aircraft;
a second lavatory proximate the first lavatory, the second lavatory comprising a second door providing access to the second lavatory from the aisle of the aircraft; and
a movable wall disposed between the first lavatory and the second lavatory,
wherein, in a first position, the movable wall separates the first lavatory from the second lavatory providing privacy therebetween, and
wherein, in a second position, the movable wall is translated toward an outer wall of the aircraft lavatory monument thereby combining the first lavatory and the second lavatory.

11. The aircraft of claim 10, wherein the movable wall is translated toward the outer wall of the aircraft lavatory monument by:
translating the movable wall in a first direction toward an interior of the aircraft;
translating the movable wall in a second direction perpendicular to the first direction toward the outer wall of the aircraft lavatory monument; and
translating the movable wall in a third direction opposite the first direction in order to stow the movable wall within the aircraft lavatory monument adjacent to the outer wall of the aircraft lavatory monument.

12. The aircraft of claim 11, wherein the aircraft lavatory monument further comprises:
a first rail, wherein the translating in the first direction and the third direction is via the first rail.

13. The aircraft of claim 12, wherein the aircraft lavatory monument further comprises:
a set of second rails, wherein the translating in the second direction is via the set of second rails.

14. The aircraft of claim 13, wherein the movable wall is coupled to the first rail and wherein the first rail is coupled to the set of second rails.

15. The aircraft of claim 10, wherein the aircraft lavatory monument further comprises:
a latching mechanism, wherein the latching mechanism is configured within the movable wall and wherein the latching mechanism comprises:
a handle; and
at least one pin, wherein the at least one pin is coupled to the handle and wherein, responsive to the handle being articulated, the at least one pin is configured to either lock the movable wall to at least one of a ceiling or a floor of the aircraft lavatory monument or unlock the movable wall to at least one of the ceiling or the floor of the aircraft lavatory monument.

16. The aircraft of claim 10, wherein the aircraft lavatory monument further comprises:
a first fixed panel, wherein, in the first position, the movable wall is temporarily coupled to the first fixed panel.

17. The aircraft of claim 16, wherein the aircraft lavatory monument further comprises:
a second fixed panel, wherein, in the second position, the movable wall is temporarily coupled to the second fixed panel.

18. The aircraft of claim 17, wherein the movable wall comprises a female interface component that interfaces with at least one of a first male interface component on the first fixed panel or a second male interface component on the second fixed panel at a given time.

19. A method of converting an aircraft lavatory monument comprising a first lavatory and a second lavatory separated by a movable wall to a combined lavatory configuration, the method comprising:
articulating a latching mechanism positioned on an exterior edge of the movable wall and accessible from an aisle of an aircraft from a first position to a second position to unlock the movable wall;
translating the movable wall in a first direction toward an interior of the aircraft;
translating the movable wall in a second direction perpendicular to the first direction toward an outer wall of the aircraft lavatory monument; and
translating the movable wall in a third direction opposite the first direction in order to stow the movable wall within the aircraft lavatory monument adjacent to the outer wall of the aircraft lavatory monument.

20. The method of claim 19, further comprising:
articulating the latching mechanism from the second position to the first position to lock the movable wall in a stowed position.
